(19) United States
(12) Patent Application Publication
(10) Pub. No.: US 2014/0034320 A1
(43) Pub. Date: Feb. 6, 2014

(54) HIGH SOLIDS CONTENT FLUID HAVING DEGRADABLE OIL

(71) Applicant: Schlumberger Technology Corporation, Sugar Land, TX (US)

(72) Inventors: Hemant Kumar J. Ladva, Missouri City, TX (US); Yiyan Chen, Sugar Land, TX (US); Anthony Loiseau, Sugar Land, TX (US); Dean Willberg, Salt Lake City, UT (US)

(73) Assignee: Schlumberger Technology Corporation, Sugar Land, TX (US)

(21) Appl. No.: 14/043,885

(22) Filed: Oct. 2, 2013

Related U.S. Application Data
(63) Continuation-in-part of application No. 13/153,529, filed on Jun. 6, 2011.

(51) Int. Cl. C09K 8/68; E21B 43/267

(52) U.S. Cl. CPC C09K 8/68; E21B 43/267
USPC 166/305.1; 507/260; 507/261; 507/267; 507/266

(57) ABSTRACT

A fluid comprising a plurality of particulates having an Apollonian particle size distribution dispersed in a carrier fluid optionally comprising a surfactant, the particulates, the carrier fluid, or both comprising a degradable oleaginous fluid. Methods to utilize the fluid are also disclosed.

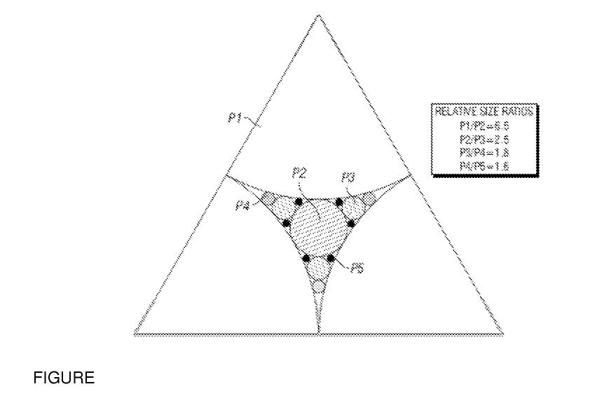

### RELATED APPLICATIONS

This application is a continuation in part of co-pending U.S. patent application Ser. No. 13/153,529, filed Jun. 6, 2011, which is fully incorporated by reference herein.

### FIELD OF THE INVENTION

The invention relates to methods for treating subterranean formations. More particularly, the invention relates to methods for improving the stability of high solid content fluid.

### BACKGROUND

The statements in this section merely provide background information related to the present disclosure and may not constitute prior art.

Hydrocarbons (oil, condensate, and gas) are typically produced from wells that are drilled into the formations containing them. For a variety of reasons, such as inherently low permeability of the reservoirs or damage to the formation caused by drilling and completion of the well, the flow of hydrocarbons into the well is undesirably low. In this case, the well is “stimulated” for example using hydraulic fracturing, chemical (usually acid) stimulation, or a combination of the two (called acid fracturing or fracture acidizing).

In hydraulic and acid fracturing, a first viscous fluid called the pad is typically injected into the formation to initiate and propagate the fracture. This is followed by a second fluid that contains a proppant to keep the fracture open after the pumping pressure is released. Granular proppant materials may include sand, ceramic beads, or other materials. In “acid” fracturing, the second fluid contains an acid or other chemical such as a chelating agent that can dissolve part of the rock, causing irregular etching of the fracture face and removal of some of the mineral matter, resulting in the fracture not completely closing when the pumping is stopped. Several types of viscosifiers are used to increase the viscosity of the fluid. These include polymers such as HEC, Xanthan, Guar, and the like, and viscoelastic surfactants. Occasionally, hydraulic fracturing can be done without a highly viscosified fluid (i.e., slick water) to minimize the damage caused by polymers or the cost of other viscosifiers.

In gravel packing, gravel is placed in the annulus of screen and formation/casing to control sand production. A carrier fluid is used to transport gravel from the surface to the formation where the gravel has to be placed. Typically two types of carrier fluids are used. The first is a brine with a low concentration of gravel (1 lb per gal of brine) and the second is a viscous fluid with high concentration of gravel (5 lb per gal of brine). Several types of viscosifiers are used to increase the viscosity of the fluid. These include polymers such as HEC, Xanthan, Guar, and viscoelastic surfactants.

The transport of solids (proppant, gravel, or other particulate or solid material) from the surface to the required depth in the well plays an important role in well stimulation. A common problem that occurs during solids transport is the setting of solids due to difference in densities of the fluid and the solid particles. If the solids start settling before the fluid reaches its destination, several problems can occur including screen outs, incomplete gravel packs, wellbore blockage, stuck tools etc. To reduce the settling rate, the carrier fluid is typically viscosified using polymers or surfactants. However, increasing the viscosity of the fluid at the surface can increase the friction pressure significantly.

In addition, the solids must provide conductivity from the formation to the well to produce hydrocarbons and other fluids from the well.

Methods disclosed herewith offer a new way to ensure the stability of the high solid content fluid while it is under downhole conditions, and which allow for improved conductivity from the formation to the well to improve production.

### SUMMARY

According to some embodiments, a fluid comprises a plurality of particulates having an Apollonian particle size distribution dispersed in a carrier fluid (optionally comprising a surfactant), the particulates, the carrier fluid, or both comprising a degradable oleaginous fluid.

According to some embodiments, a method comprises providing a treatment fluid comprising a plurality of particulates having an Apollonian particle size distribution dispersed in a carrier fluid (optionally comprising a surfactant), the particulates, the carrier fluid, or both comprising a degradable oleaginous fluid; and introducing the fluid into a wellbore.

### BRIEF DESCRIPTION OF THE DRAWINGS

The FIGURE illustrates a pentamodal Apollonian particle packing model based on the Descartes circle theorem involving mutually tangent circles, according to some embodiments of the current application.

### DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating the preferred embodiments and should not be construed as a limitation to the scope. While the compositions are described herein as comprising certain materials, it should be understood that the composition could optionally comprise two or more chemically different materials. In addition, the composition can also comprise some components other than the ones already cited. In the summary and this detailed description, each numerical value should be read once as modified by the term “about” (unless already expressly so modified), and then read again as not so modified unless otherwise indicated in context. Also, in the summary and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

The following definitions are provided in order to aid those skilled in the art in understanding the detailed description.

The term “treatment,” or “treating,” refers to any subterranean operation that uses a fluid in conjunction with a desired function and/or for a desired purpose. The term “treatment,” or “treating,” does not imply any particular action by the fluid.

The term “fracturing” refers to the process and methods of breaking down a geological formation and creating a fracture, i.e. the rock formation around a well bore, by pumping fluid at very high pressures (pressure above the determined closure pressure of the formation), in order to increase production rates from a hydrocarbon reservoir. The fracturing methods otherwise use conventional techniques known in the art.

The term “proppant” includes proppant or gravel used to hold fractures open and also includes gravel or proppant used in a gravel packing and/or a frac-pack operation.

“Carrier,” “fluid phase” or “liquid phase” refer to the fluid or liquid that is present as a continuous phase in the fluid. Reference to “aqueous phase” refers to a carrier phase comprised predominantly of water, which may be a continuous or dispersed phase. As used herein the terms “liquid” or “liquid phase” encompasses both liquids per se and supercritical fluids, including any solutes dissolved therein.

The terms “particulate,” “particle” and “particle size” used herein refer to discrete quantities of solids, gels, semi-solids, liquids, gases and/or foams unless otherwise specified.

As used herein, a blend of particles and a fluid may be generally referred to as a slurry, an emulsion, or the like. For purposes herein “slurry” refers to a mixture of solid particles dispersed in a fluid carrier. An “emulsion” refers to a form of slurry in which the particles are of a size such that the particles do not exhibit a static internal structure, but are assumed to be statistically distributed. In some embodiments, an emulsion is a mixture of two or more liquids that are normally immiscible (nonmixable or unblendable). For purposes herein, an emulsion comprises at least two phases of matter, which may be a first liquid phase dispersed in a continuous (second) liquid phase, and/or a first liquid phase and one or more solid phases dispersed in a continuous (second) liquid phase. Emulsions may be oil-in-water, water-in-oil, or any combination thereof, e.g., a “water-in-oil-in-water” emulsion or an “oil-in-water-in-oil” emulsion.

The terms “flowable,” “pumpable” or “mixable” are used interchangeably herein and refer to a blend of particles and a liquid having either a yield stress or low-shear (5.11 s⁻¹) viscosity less than 1000 Pa and a dynamic apparent viscosity of less than 10 Pa-s (10,000 cP) at a shear rate 170 s⁻¹, where yield stress, low-shear viscosity and dynamic apparent viscosity are measured at a temperature of 25° C. unless another temperature is specified explicitly or in context of use.

Apollonian packing of spheres refers to the presence of successively smaller spheres to fit in the interstices of the larger spheres. For example, randomly packed monodisperse spheres, regardless of size, may have a packed volume fraction (PVF) of 0.64. By providing smaller spheres that can occupy the interstices between the larger spheres, the overall PVF can be increased. The FIGURE illustrates an approximate pentamodal Apollonian packing model obtained using the Descartes circle theorem. For four mutually tangent circles with curvatures Pₙ, Pₙ₊₁, Pₙ₊₂, Pₙ₊₃, the following equation (1) is applicable:

$$\frac{1}{{P}_{n}^{2}} + \frac{1}{{P}_{n + 1}^{2}} + \frac{1}{{P}_{n + 2}^{2}} + \frac{1}{{P}_{n + 3}^{2}} = \frac{1}{2} {( \frac{1}{{P}_{n}} + \frac{1}{{P}_{n + 1}} + \frac{1}{{P}_{n + 2}} + \frac{1}{{P}_{n + 3}} )}^{2} \qquad ( 1 )$$

where Pₙ is the curvature of circle n, where curvature is taken as the reciprocal of the radius. For example, when three equally sized spheres (Size P1=1) are touching each other, the size (diameter) ratio of P1/P2 can be obtained using the above equation to be 6.464˜6.5. Similarly, other ratios for successively smaller particle sizes required can be estimated as P2/P3 being about 2.5 and P3/P4 being about 1.8, and when a fifth particle is used, P4/P5 is about 1.6.

As used herein, the terms “Apollonianistic,” “Apollonianistic packing,” “Apollonianistic rule,” “Apollonianistic particle size distribution,” “Apollonianistic PSD” and similar terms, refer to a multimodal volume-averaged particle size distribution with particle size distribution (PSD) modes that are not necessarily strictly Apollonian wherein either (1) a first PSD mode comprises particulates having a volume-averaged median size (diameter) at least 1.5 times larger, or 3 times larger than the volume-average median size of at least a second PSD mode such that a packed volume fraction (PVF) of the particulates present in the mixture exceeds 0.75 or (2) the particle mixture comprises at least three PSD modes, wherein a first amount of particulates have a first PSD mode, a second amount of particulates have a second PSD mode, and a third amount of particulates have a third PSD mode, wherein the first PSD mode is from 1.5 to 25 times, or from 2 to 10 times larger than the second PSD mode, and wherein the second PSD mode is at least 1.5 times larger than the third PSD mode.

Treatment fluids having an Apollonian particle size distribution are referred to as high solid content fluids (HSCF), which show promise in many aspects for fracturing fluid and other well treatment processes. For example, in shale gas formation, current practice requires a high pumping rate with low viscosity fluid carrying low concentrations of proppant to stimulate the formation. Such limitations result in obvious issues such as high water usage and high energy consumption. In addition, the effectiveness of the stimulation is depends on the ability to keep the fracture propped and open for production. HSCF has a low water content, a high density and hence a high hydrostatic pressure with a low horse power requirement relative to treatments known in the art. In addition, the HSCF carries proppant wherever the fracture is formed, which ensures good stimulation efficiency.

For HSCF, water retention is very important since small amount of fluid loss could render the fluid completely immobile. Fluid loss control or water retention for HSCF is achieved mainly by two methods. The first is to construct the HSCF with solid particles following a certain particle size distribution, where the holes created by bigger particles are filled by smaller particles. It has been demonstrated that if the particles construction follows Apollonian packing parameters, good leak off control can be achieved. The second method is to use polymer latex material when enough pressure differential is applied and liquid content is reduced, the latex will film and form an impermeable barrier. Method one and two are used mostly in combination in the HSCF system since the leakoff control requirement is much higher than for conventional fluids. The particle packing creates small enough holes for the latex particles to plug and building film on.

For Apollonian packing of particles to stop fluid loss, the particle sizes need to extend to a few nanometer sizes when the gap or capillaries formed in these packing systems will become small enough to close the 10,000 psi capillary pressure present under such conditions. This pressure can essentially stop any fluid loss. However, such ideal gradients of particles to achieve such fluid loss control are challenging in practice. When it comes to production, the small particles must provide the required fluid loss, but must also be at least partially removed during clean-up operations to yield permeability of the pack for producing fluid. Latex is very effective in building an impermeable layer that prevents fluid from leaking off to the formation. Since the polymer latex is used above its glass transition temperature, it is usually pliable and can deform to seal small gaps without the need to be exact in particle sizes. However, when it comes to production, the impermeable layer is problematic, i.e. the formation fluid may not be able to produce through the layer. It is difficult to degrade latex films to produce the needed permeability.

In the currently disclosed embodiments, a new method/material is disclosed for both fluid loss control and cleanup of a high solids content fluid system.

In an embodiment, a fluid comprises a plurality of particulates having an Apollonian particle size distribution dispersed in a carrier fluid comprising a surfactant, the particulates, the carrier fluid, or both comprising a degradable oleaginous fluid. In an embodiment, the treatment fluid may have specific droplet sizes and concentrations to provide control over the time required to break, diminish, or otherwise remove at least a portion of the cross-linking of the polymers with a subsequent reduction in the viscosity of the fluid.

In an embodiment, a portion of the fluid comprises particulates comprising micelles. In an embodiment, the carrier fluid comprises the degradable oleaginous fluid as a continuous phase. In an embodiment, the carrier fluid comprises an oil-in-water emulsion and/or a water-in-oil-in-water emulsion comprising a discontinuous phase comprising the degradable oleaginous fluid dispersed in an aqueous continuous phase. In an alternative embodiment, the carrier fluid comprises a water-in-oil emulsion comprising an aqueous discontinuous phase dispersed in a continuous phase comprising the degradable oleaginous fluid.

In embodiments, the particulate material comprises proppant. In embodiments, the fluid may further comprise a viscosifying agent.

In embodiments, the particulate material comprises a second average particle size mode between three to twenty times smaller than a first average particle size mode. In embodiments, the fluid may further comprise a third average particle size mode, which is three to twenty times smaller than the second average particle size mode.

In an embodiment, the degradable oleaginous fluid is selected from the group consisting of an oleophilic monocarboxylic acid ester comprising from 3 to 40 carbon atoms, an oleophilic polycarboxylic acid ester comprising from 3 to 40 carbon atoms, an oleophilic ether comprising from 3 to 40 carbon atoms, an oleophilic alcohol comprising from 3 to 40 carbon atoms, and combinations thereof. In an embodiment, the degradable oleaginous fluid is non-toxicological.

In an embodiment, the degradable oleaginous fluid undergoes hydrolysis upon contact with an aqueous solution having a pH from about 9 to 14 or a pH from about 0 to 5.

In an embodiment, a method and material to control fluid loss in the hydraulic fracturing treatment is disclosed. The leakoff control is achieved by using surfactant to form micelles and these micelles act as small “particles” to plug pore throats. In an embodiment, the micelles comprise the degradable oleaginous fluid. The pore throats can be created by either the formation rock or the HSCF particle packing. Oil can be used to control the “particle” (droplet, or oil inclusive micelles, i.e. emulsion droplets) size to give best performances. Surfactant molecule sizes can also be changed to give different “particle” sizes. The micelles and/or emulsion droplet can act as particles for filling the right size of pore throats for fluid loss control. The droplets can also have certain flexibility (pliability) to deform and seal non-exact size pore throats. This method can be used together with the HSCF system, but is not limited to this system.

In further embodiments, the degradable oil within the pack formed, which may include the surfactant micelles or emulsion droplets, can be destroyed after the stimulation. The destruction may be produced by emulsion droplets increasing in size by diffusion of more oil (such as from the formation) into the droplets until lyse occurs, destroying the droplets, and/or by reaction of the droplets with a de-emulsifier, and/or degrading the emulsifier to destabilize the droplets and thus, destroy at least a portion of the particulates present in the pack.

As described, fluid loss control in HSCF may be achieved by using particles, including fine emulsion droplets comprising a degradable oil, to plug the pore throats present in an Apollonianistic packing of particles, creating an impermeable barrier to flow. In order to stop leakoff, the particle size must be properly selected to match the pore throats.

Without wishing to be bound by any theory, it is believed that “particles” formed by surfactant micelles comprising degradable oil droplets stabilized by surfactant are used as a fluid control agent. The particles formed this way can be controlled by the specific surfactants used, the type and amount of discontinuous phase (e.g., the degradable oil) used, and the like. A wide spectrum of particle sizes can be achieved in this way. Since the particles formed here are based on self-assembly with Van der Walls force, they are not completely rigid particles. Under certain pressure and temperature conditions, the particles are subject to being deformed to accommodate shape changes necessary to plug the remaining holes present in the packing. The particles formed in this way will help fluid loss control by both plugging the right pores throats and be pliable to seal not perfectly fit holes. In other words, embodiments disclosed herein have the property of a film forming particle (e.g., such as latex) and a discrete particle property, (e.g., such as fumed silica). It can form “film-like” low permeability layer during stimulation treatments, and then be destroyed or degraded to remove the particle and increase permeability of the pack.

In an embodiment, the degradable oleaginous fluid, also referred to as a degradable oil, may comprise an ester, an ether, an amide, an amine, an alcohol, a glycoside, or a combination thereof, and may have a solubility in water of less than 10 wt %, or less than 5 wt %, or less than 1 wt % at 25° C.

In embodiments, the degradable oleaginous fluid is selected from the group consisting of an oleophilic monocarboxylic acid ester comprising from 3 to 40 carbon atoms, an oleophilic polycarboxylic acid ester comprising from 3 to 40 carbon atoms, an oleophilic ether comprising from 3 to 40 carbon atoms, an oleophilic alcohol comprising from 3 to 40 carbon atoms, an oleophilic amide comprising from 3 to 40 carbon atoms, an oleophilic amine comprising from 3 to 40 carbon atoms, and combinations thereof. For purposes herein, a material having a solubility in water of less than 10 wt %, or less than 5 wt %, or less than 1 wt % at 25° C. is said to be oleophilic. In an embodiment, the degradable oleaginous fluid may comprise two or more moieties attached via a functional group, e.g., a carboxylic acid, an alcohol, an amine, an amide, a glycoside, an ether, in which the chain length of one of the moieties is from 1 to 40, or from 6 to 30, or from 8 to 15 carbon atoms, with the remaining carbon atoms, or hydrogen atom(s) in the case of an alcohol or an amine, forming the other moiety or moieties.

In an embodiment, the degradable oleaginous fluid has a hydrophilic-lipophilic balance of less than 16, or less than 14, or less than 12, or less than 10, as determined according to Griffin's method on a scale from 0 to 20 as is readily understood by one having minimal skill in the art.

In embodiments, the degradable oleaginous fluid is converted from a relatively water insoluble oil into its water soluble components upon exposure to temperature, biological agents, acids, bases, and/or the like present at, or provided to the intended location of the fluid for a particular use. In an embodiment, the degradable oleaginous fluid undergoes hydrolysis at a pH from about 0 to 14, or at a pH of greater than or equal to about 9, e.g., from about 9 to 14 or higher, and/or at a pH of less than or equal to about 4, e.g., from about 4 to about 0 or less.

In an embodiment, the oleaginous fluid comprises a monocarboxylic acid ester having ecologically acceptable components from the class of so-called non-polluting oils. Examples include esters of “lower” carboxylic acids having from 1 to 10 carbons. Suitable lower monocarboxylic acids include the reaction products of monofunctional alcohols, polyfunctional alcohols, and the like. Suitable alcohols include di- to tetra-hydric alcohols, lower alcohols of this type, including having 2 to 6 carbon atoms. Examples of such poly-hydric alcohols include aliphatic glycols and/or propanediols such as ethylene glycol, 1,2-propanediol and/or 1,3-propanediol. Suitable alcohols can be of natural and/or synthetic origin. Straight-chain and/or branched alcohols may be used herein.

In an embodiment, the ester oils may be the reaction product of long-chain acids having from 11 to 40 carbon atoms, which may include unsaturated and/or polyunsaturated acids. The carboxylic acid radicals present can be of vegetable and/or animal origin. Vegetable starting materials include, for example, palm oil, peanut oil, castor oil and/or rapeseed oil. The carboxylic acids of animal origin include tallow, fish oils, rendering oils, and the like. Other suitable degradable oils include anchovy oil, castor oil, palm oil, virgin coconut oil, salmon oil, sunflower oil, soy bean oil, cod liver oil, oil, C₁₀₋₂₈ fatty acid C₁₋₁₀ alkyl esters (e.g., fatty acid methyl esters), and the like.

In an embodiment, the ester-containing degradable oleaginous oil is contacted with dilute alkali to produce a salt and an alcohol, thereby increasing the porosity of the pack. The formation of alcohol reduces the surface tension and alters wettability. In the case of an emulsion with water as a continuous phase and the ester based oil as the dispersed phase, the hydrolysis of the oil will reduce the surface tension of the continuous water phase and enhance wettability, which will likewise enhance the flowback and cleanup.

In an embodiment, the degradable oleaginous oil may include an ester, which, when contacted with an acid will hydrolyze to produce an acid and an alcohol, which may reduce the surface tension and enhance the wettability of the formation.

In an embodiment, the degradable oleaginous fluid is non-toxicological, meaning it does not degrade into toxic substances, or substances which have an acute toxicity such that they would be considered hazardous or toxic in the intended environment. In an embodiment, the degradable oleaginous fluid comprises less than about 1 wt % aromatic content, or less than about 0.5 wt %, or less than 0.1 wt % aromatic content.

In an embodiment, the degradable oleaginous fluid comprises a linear alpha olefin, which may be of natural or synthetic origin.

In an embodiment, the degradable oleaginous fluid may comprise various substituted and/or fully esterified triglycerides.

In an embodiment, the degradable oleaginous fluid may comprise C₂-C₁₂ alkoxylates, e.g., ethoxylates, propoxylates, and/or the like, including alkoxylated alcohols, acids, polyethers, amines, amides, glycosides, and/or the like.

Suitable degradable oleaginous fluids include FlexiSOLV® dibutyl ester (DBE) (INVISTA, Koch Industries, USA), which are high boiling oxygenated solvents that are miscible with organic solvents, low odor and flammability, comprising refined dimethyl esters of adipic, glutaric and succinic acids. The DBE esters undergo reactions expected of the ester group such as hydrolysis and transesterification. At low and high pH the DBE esters are hydrolyzed to the corresponding acids, their salts and alcohol. The dibutyl ester components of dimethyl succinate, dimethyl glutarate and dimethyl adipate are readily biodegradable.

Suitable examples further include AMSOIL® biodegradable oil (AMSOIL INC., USA) which is designed to biodegrade when subjected to sunlight, water and microbial activity. The biodegradable oil is a blend of oleic vegetable oils and customized synthetic esters. AMSOIL® oil exhibits high biodegradability and low aquatic toxicity, along with superior oxidative stability, and low temperature performance. It contains anti-oxidants that ensure long oil life and foam inhibitors that promote problem-free operation, it is hydrolytically stable and ideal for use where water contamination is a problem.

Other suitable degradable oleaginous fluids include those disclosed in U.S. Pat. Nos. 4,374,737; 4,614,604; 4,802,998; 5,232,910; 5,252,554; 5,254,531; 5,318,954; 5,318,956; 5,348,938; 5,403,822; 5,441,927; 5,461,028; 5,663,122; 5,755,892; 5,846,601; RE 36,066; 5,869,434; 6,022,833; 6,122,860; 6,165,946; 6,289,989; 6,350,788; 6,716,799; 6,806,235; 6,828,279; 7,041,738; 7,666,820; 7,741,248; and 8,236,735: all of which are hereby incorporated by reference.

The surfactant, when present, may be selected from the group consisting of cationic, anionic, zwitterionic, amphoteric, nonionic and combinations thereof. Some non-limiting examples are those cited in U.S. Pat. No. 6,435,277 and U.S. Pat. No. 6,703,352, each of which are incorporated herein by reference. In general, particularly suitable zwitterionic surfactants have the formula:

RCONH—(CH₂)ₐ(CH₂CH₂O)ₘ(CH₂)_{b}—N⁺—(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactants of the family of betaine is used.

Exemplary cationic surfactants include the amine salts and quaternary amine salts disclosed in U.S. Pat. Nos. 5,979,557, and 6,435,277 which are hereby incorporated by reference. Examples of suitable cationic surfactants include cationic surfactants having the structure:

R¹N⁺(R²)(R³)(R⁴)X—

in which R¹ has from about 14 to about 26 carbon atoms and may be branched or straight chained, aromatic, saturated or unsaturated, and may contain a carbonyl, an amide, a retroamide, an imide, a urea, or an amine; R², R³, and R⁴ are each independently hydrogen or a C₁ to about C₆ aliphatic group which may be the same or different, branched or straight chained, saturated or unsaturated and one or more than one of which may be substituted with a group that renders the R², R³, and R⁴ group more hydrophilic; the R², R³, and R⁴ groups may be incorporated into a heterocyclic 5- or 6-member ring structure which includes the nitrogen atom; the R², R³, and R⁴ groups may be the same or different; R¹, R², R³, and/or R⁴ may contain one or more ethylene oxide and/or propylene oxide units; and X⁻ is an anion. Mixtures of such compounds are also suitable. As a further example, R¹ is from about 18 to about 22 carbon atoms and may contain a carbonyl, an amide, or an amine, and R², R³, and R⁴ are the same as one another and contain from 1 to about 3 carbon atoms.

Amphoteric surfactants are also suitable. Exemplary amphoteric surfactant systems include those described in U.S. Pat. No. 6,703,352, for example amine oxides. Other exemplary surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The surfactant may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R¹CON(R²)CH₂X

wherein R¹ is a hydrophobic chain having about 12 to about 24 carbon atoms, R² is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecenyl group, an octadecyl group, and a docosenoic group.

In an embodiment, a method comprises providing a fluid comprising a plurality of particulates having an Apollonian particle size distribution dispersed in a carrier fluid comprising a surfactant, the particulates, the carrier fluid, or both comprising an degradable oleaginous fluid; and introducing the fluid into a wellbore.

According to one embodiment, the treatment fluid is used as a fracturing fluid. The carrier fluid includes any base fracturing fluid understood in the art. Some non-limiting examples of carrier fluids include hydratable gels (e.g. guars, poly-saccharides, xanthan, hydroxy-ethyl-cellulose, etc.), a cross-linked hydratable gel, a viscosified acid (e.g. gel-based), an emulsified acid (e.g. oil outer phase), an energized fluid (e.g. an N₂ or CO₂ based foam), and an oil-based fluid including a gelled, foamed, or otherwise viscosified oil, which may include the degradable oleaginous oil. Additionally, the carrier fluid may be a brine, and/or may include a brine. The carrier fluid may be water, DI water, tap water, seawater, produced water or any type of water available in the field.

The treatment fluid may further include, a viscosifying agent. In an embodiment, the viscosifying agent may be a crosslinked polymer, including a metal-crosslinked polymer. Suitable polymers for making the metal-crosslinked polymer viscosifiers include, for example, polysaccharides such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds, and synthetic polymers. Crosslinking agents based on boron, titanium, zirconium or aluminum complexes are typically used to increase the effective molecular weight of the polymer and make them better suited for use in high-temperature wells.

Other suitable classes of polymers effective as viscosifying agent include polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

Cellulose derivatives are used to a smaller extent, such as hydroxyethylcellulose (HEC) or hydroxypropylcellulose (HPC), carboxymethylhydroxyethylcellulose (CMHEC) and carboxymethycellulose (CMC), with or without crosslinkers. Xanthan, diutan, and scleroglucan, three biopolymers, have been shown to have excellent particulate-suspension ability even though they are more expensive than guar derivatives and therefore have been used less frequently, unless they can be used at lower concentrations.

In other embodiments, the viscosifying agent is made from a crosslinkable, hydratable polymer and a delayed crosslinking agent, wherein the crosslinking agent comprises a complex comprising a metal and a first ligand selected from the group consisting of amino acids, phosphono acids, and salts or derivatives thereof. Also the crosslinked polymer can be made from a polymer comprising pendant ionic moieties, a surfactant comprising oppositely charged moieties, a clay stabilizer, a borate source, and a metal crosslinker. Said embodiments are described in U.S. Patent Publications US2008-0280790 and US2008-0280788 respectively, each of which are incorporated herein by reference.

The viscosifying agent may be present in a lower amount than conventionally is included for a fracture treatment. The loading of a viscosifier, for example described in pounds of gel per 1,000 gallons of carrier fluid, is selected according to the particulate size (due to settling rate effects) and loading that a storable composition must carry, according to the viscosity required to generate a desired fracture geometry, according to the pumping rate and casing or tubing configuration of the wellbore, according to the temperature of the formation of interest, and according to other factors understood in the art.

In certain embodiments, the low amount of a viscosifying agent includes a hydratable gelling agent in the carrier fluid at less than 20 pounds per 1,000 gallons of carrier fluid where the amount of particulates in the storable composition are greater than 16 pounds per gallon of carrier fluid. In certain further embodiments, the low amount of a viscosifier includes a hydratable gelling agent in the carrier fluid at less than 20 pounds per 1,000 gallons of carrier fluid where the amount of particulates in the fracturing slurry are greater than 23 pounds per gallon of carrier fluid. In certain embodiments, the low amount of a viscosifier includes the carrier fluid with no viscosifier included. In certain embodiments a low amount of a viscosifier includes values greater than the listed examples, because the circumstances of the storable composition conventionally utilize viscosifier amounts much greater than the examples. For example, in a high temperature application with a high proppant loading, the carrier fluid may conventionally indicate a viscosifier at 50 lbs. of gelling agent per 1,000 gallons of carrier fluid, wherein 40 lbs. of gelling agent, for example, may be a low amount of viscosifier. One of skill in the art can perform routine tests of storable composition based on certain particulate blends in light of the disclosures herein to determine acceptable viscosifier amounts for a particular embodiment.

In certain embodiments, the carrier fluid includes an acid. The fracture may be a traditional hydraulic bi-wing fracture, but in certain embodiments may be an etched fracture and/or wormholes such as developed by an acid treatment. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, etc., and further upon compatibility with the formation, compatibility with fluids in the formation, and compatibility with other components of the fracturing slurry and with spacer fluids or other fluids that may be present in the wellbore. The selection of an acid for the carrier fluid is understood in the art based upon the characteristics of particular embodiments and the disclosures herein.

The treatment fluid includes a particulate material. In one embodiment, the particulate material is a blend made of proppant. Proppant selection involves many compromises imposed by economical and practical considerations. Criteria for selecting the proppant type, size, size distribution in multimodal proppant selection, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated (curable), or pre-cured resin coated. Proppants and gravels in the same or different wells or treatments can be the same material and/or the same size as one another and the term proppant is intended to include gravel in this disclosure. In some embodiments, irregular shaped particles may be used. International application WO 2009/088317 discloses a method of fracturing with a slurry of proppant containing from 1 to 100 percent of stiff, low elasticity, low deformability elongated particles. US patent application 2007/768393 discloses proppant that is in the form of generally rigid, elastic plate-like particles having a maximum to minimum dimension ratio of more than about 5, the proppant being at least one of formed from a corrosion resistant material or having a corrosion resistant material formed thereon. In general the proppant used will have an average particle size of from about 0.15 mm to about 4.76 mm (about 100 to about 4 U.S. mesh), preferably from about 0.15 mm to about 3.36 mm (about 100 to about 6 U.S. mesh), more preferably from about 0.15 mm to about 4.76 mm (about 100 to about 4 U.S. mesh), more particularly, but not limited to 0.25 to 0.42 mm (40/60 mesh), 0.42 to 0.84 mm (20/40 mesh), 0.84 to 1.19 mm (16/20 mesh), 0.84 to 1.68 mm (12/20 mesh) and 0.84 to 2.38 mm (8/20 mesh) sized materials. Normally the proppant will be present in the slurry in a concentration from about 0.12 to about 0.96 kg/L, or from about 0.12 to about 0.72 kg/L, or from about 0.12 to about 0.54 kg/L. Also, there are slurries where the proppant is at a concentration up to 16 PPA (1.92 kg/L). If the slurry is foamed the proppant is at a concentration up to 20 PPA (2.4 kg/L). The storable composition is not a cement slurry composition.

The treatment fluid is a slurry comprising particulate materials with defined particles size distribution. On example of realization is disclosed in U.S. Pat. No. 7,784,541, herewith incorporated by reference in its entirety. In certain embodiments, the selection of the size for the first amount of particulates is dependent upon the characteristics of the propped fracture, for example the closure stress of the fracture, the desired conductivity, the size of fines or sand that may migrate from the formation, and other considerations understood in the art. In certain further embodiments, the selection of the size for the first amount of particulates is dependent upon the desired fluid loss characteristics of the first amount of particulates as a fluid loss agent, the size of pores in the formation, and/or the commercially available sizes of particulates of the type comprising the first amount of particulates.

In certain embodiments, the selection of the size of the second amount of particulates is dependent upon maximizing or optimizing a packed volume fraction (PVF) of the mixture of the first amount of particulates and the second amount of particulates. The packed volume fraction or packing volume fraction (PVF) is the fraction of solid content volume to the total volume content. A second average particle size of between about seven to ten times smaller than the first amount of particulates contributes to maximizing the PVF of the mixture, but a size between about three to twenty times smaller, and in certain embodiments between about three to fifteen times smaller, and in certain embodiments between about three to ten times smaller will provide a sufficient PVF for most slurry. Further, the selection of the size of the second amount of particulates is dependent upon the composition and commercial availability of particulates of the type comprising the second amount of particulates. In certain embodiments, the particulates combine to have a PVF above 0.70, 074 or 0.75 or above 0.80. In certain further embodiments the particulates may have a much higher PVF approaching 0.95. The optimization of the particles sizes distribution (Apollonian distribution), and dispersion of particles with high surface area lead to make fluids with high solid content (solid volume fraction from 50 to 70%).

The slurry may further include a third amount of particulates having a third average particle size that is smaller than the second average particle size. In certain further embodiments, the slurry may have a fourth, a fifth or a sixth amount of particles. Also in some embodiments, the same chemistry can be used for the third, fourth, fifth or sixth average particle size. Also in some embodiments, different chemistry can be used for the same third average particle size: e.g. in the third average particle size, half of the amount is a certain type of proppant and the other half is another type of proppant. For the purposes of enhancing the PVF of the slurry, more than three or four particles sizes will not typically be required. However, additional particles may be added for other reasons, such as the chemical composition of the additional particles, the ease of manufacturing certain materials into the same particles versus into separate particles, the commercial availability of particles having certain properties, and other reasons understood in the art.

In an embodiment, the treatment fluid may comprise fumed silica. Fumed silica also known as pyrogenic silica consists of microscopic droplets of amorphous silica fused into branched, chainlike, three-dimensional secondary particles which then agglomerate into tertiary particles. The resulting powder has an extremely low bulk density and high surface area. The fumed silica is present in the treatment fluid in a concentration to reduce the settling rate of the particulate material in the treatment fluid. The concentration is less than about 2% by weight of the treatment fluid. In further embodiment, the concentration is less than about 1% by weight of the treatment fluid. In further embodiment, the concentration is less than about 0.6% by weight of the treatment fluid. In further embodiment, the concentration is in the range of about 0.001% to about 0.5% by weight of the treatment fluid. In further embodiment, the concentration is in the range of about 0.1% to about 0.5% by weight of the treatment fluid. Fumed silica particles are compatible with current common additives: leak-off control additives (latex, nanoparticles, viscosifier . . . ) and antifoam, dispersant, surfactant.

According to a further embodiment, the treatment fluid may further comprise a degradable solid or particulate material. In certain embodiments, the degradable material includes at least one of a lactide, a glycolide, an aliphatic polyester, a poly(lactide), a poly(glycolide), a poly(.epsilon.-caprolactone), a poly(orthoester), a poly(hydroxybutyrate), an aliphatic polycarbonate, a poly(phosphazene), and a poly(anhydride). In certain embodiments, the degradable material includes at least one of a poly(saccharide), dextran, cellulose, chitin, chitosan, a protein, a poly(amino acid), a poly(ethylene oxide), and a copolymer including poly(lactic acid) and poly(glycolic acid). In certain embodiments, the degradable material includes a copolymer including a first moiety which includes at least one functional group from a hydroxyl group, a carboxylic acid group, and a hydrocarboxylic acid group, the copolymer further including a second moiety comprising at least one of glycolic acid and lactic acid.

In an embodiment, the degradable material is selected from substituted and unsubstituted lactide, glycolide, polylactic acid, polyglycolic acid, copolymers of polylactic acid and polyglycolic acid, copolymers of glycolic acid with other hydroxy-, carboxylic acid-, or hydroxycarboxylic acid-containing moieties, copolymers of lactic acid with other hydroxy-, carboxylic acid-, or hydroxycarboxylic acid-containing moieties, and mixtures of such materials. Preferred examples are polyglycolic acid or PGA, and polylactic acid or PLA. These materials function as solid-acid precursors, and upon dissolution in the fracture, can form acid species which can have secondary functions in the fracture as for example clean-up of the unwanted particulate material or treatment fluid additives.

In some embodiments, the treatment fluid can be made to be partially degradable when particles other than proppant are degradable i.e. they could disappear after a certain amount of time (following different processes: thermal degradation, thermal decomposition, dissolution etc.). Degradation of particles leads to increase the permeability of the proppant pack. Degradation should take place after placement. Several kind of degradable particles can be used, including a mineral (e.g., a salt) and/or an organic compound (e.g., PLA, PGA, wax, and the like), or any combination thereof.

In some embodiments, the treatment fluid can comprise fiber. A first type of fiber additive can provide reinforcement and consolidation of the proppant. This fiber type can include, for example, glass, ceramics, carbon and carbon-based compounds, metals and metallic alloys, and the like and combinations thereof, as a material that is packed in the proppant to strengthen the proppant pillars. And in other applications, a second type of fiber can be used that inhibits settling of the proppant in the treatment fluid. The second fiber type can include, for example, polylactic acid, polyglycolic acid, polyethylterephthalate (PET), polyol, and the like and combinations thereof, as a material that inhibits settling or dispersion of the proppant in the treatment fluid and serves as a primary removable fill material in the spaces between the pillars. Yet other applications include a mixture of the first and second fiber types, the first fiber type providing reinforcement and consolidation of the proppant and the second fiber type inhibiting settling of the proppant in the treatment fluid.

The fibers can be hydrophilic or hydrophobic in nature. Hydrophilic fibers are preferred in one embodiment. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like.

In some embodiments, the treatment fluid may optionally further comprise additional additives, including, but not limited to, acids, fluid loss control additives, gas, corrosion inhibitors, scale inhibitors, catalysts, clay control agents, biocides, friction reducers, combinations thereof and the like. For example, in some embodiments, it may be desired to foam the first or second treatment fluid using a gas, such as air, nitrogen, or carbon dioxide.

The treatment fluids may be used for carrying out a variety of subterranean treatments, including, but not limited to, drilling operations, fracturing treatments, and completion operations (e.g., gravel packing) In some embodiments, the treatment fluids may be used in treating a portion of a subterranean formation. In certain embodiments, a treatment fluid may be introduced into a well bore that penetrates the subterranean formation. Optionally, the treatment fluid further may comprise particulates and other additives suitable for treating the subterranean formation. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, StimPac® treatments, or other names), which are also used extensively to stimulate the production of hydrocarbons, water and other fluids from subterranean formations. These operations involve pumping a slurry of in hydraulic fracturing or gravel in gravel packing In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

In certain embodiments, the treatment fluids may be used for providing some degree of sand control in a portion of the subterranean formation. In the sand control embodiments, the treatment fluid is introduced into the well bore that penetrates the subterranean formation such that the particulates form a gravel pack in or adjacent to a portion of the subterranean formation.

In an embodiment, a high solid content fluid containing a multimodal sized proppants (Apollonian particle size distribution), a viscosifying agent such as diutan or guar and a direct emulsion as a carrier fluid is placed in a fracture. The emulsion is a carrier fluid with water as the continuous phase and the degradable oil as the dispersed phase. The water phase may contain a gelling agent such as Diutan polymer. The dispersed oil droplets will undergo hydrolysis over a period of time during which acid and salt would be produced. With time the oil droplets will degrade in the presence of water and will create a more conductive pathway through the proppant pack. The single phase fluid will also help in the cleanup during flowback. Acid such as encapsulated fumaric acid may also be used in the formulation such that the acid released with time or closure stress will aid in the catalyzed hydrolysis,

The presence of degradable or reactive oil such as ester oils could have beneficial impact on the cleaning process of hydraulic fracturing fluids (including high solid content fluids) based on cross-linked gels (such as conventional cross-linked guar). To induce the cross-linkage of a bio polymer such as guar, the pH of the solution must be basic. In presence of an excess of water and heat, the hydrolysis of the ester function releases hydronium ions which decrease the pH of the solution and induce a de-crosslinking of the gel; thus the hydrolysis of the oil leads to cleaning without conventional breakers such as oxidizers and breaker aids. In an embodiment, a change in pH may be used to specifically de crosslink the gel rather than break or otherwise reduce the polymer chains to produce at least partially de-crosslinked polymers having properties consistent with linear gels, which are conducive to particle and/or fiber segregation.

In an embodiment, the treatment fluid may comprise a high solid content fluid with high packing volume fraction created by the Apollonian approach having specific particle size distributions and concentrations of various particle size distributions to provide control over the time allowed for the breaking or removal of at least a portion of the cross-linking of the polymers with a subsequent reduction in the viscosity of the fluid or to induce other changes in the properties of the fluid.

A high solid content fluid, with high packing volume fraction created by the Apollonian approach decreases the permeability of the proppant pack significantly and thus may have a negative impact on the oil or gas production. However presence of degradable or reactive oil such ester oils in the fluid formulation could have beneficial impact on the cleaning process of high solid content fluids containing acid sensitive materials such as calcium carbonate particles. In presence of an excess of water and heat, the hydrolysis of the ester could lead to the formation of acid carboxylic function which could react with the calcium carbonate to release water and carbon dioxide through the next two steps reaction as given below, and will enhance proppant pack conductivity, cleanup and flowback.

2RCOOH+CaCO₃→H₂CO₃+Ca(RCOO)₂. a)

H₂CO₃→H₂O+CO₂. b)

If hydronium ion is directly released from the carboxylic acid, the reaction is:

2H⁺(aq)+CaCO₃(s)→Ca⁺²(aq)+H₂O(l)+CO₂(g)

In an embodiment, the generated acid may also be used as a trigger to initiate a reaction with other additives within the proppant pack.

### Embodiments

As is evident from the disclosure herein, a variety of embodiments are contemplated:
1. A treatment fluid comprising:
   a plurality of particulates having an Apollonian particle size distribution dispersed in a carrier fluid, wherein the particulates, the carrier fluid, or both comprise a degradable oleaginous fluid.
2. The treatment fluid of embodiment 1, further comprising a surfactant wherein a portion of the particulates comprise micelles.
3. The treatment fluid of embodiments 1 or 2, wherein the carrier fluid comprises the degradable oleaginous fluid as a continuous phase.
4. The treatment fluid of any one of embodiments 1 through 3, wherein the carrier fluid comprises an oil-in-water emulsion or a water-in-oil-in-water emulsion comprising a discontinuous phase comprising the degradable oleaginous fluid dispersed in an aqueous continuous phase.
5. The treatment fluid of any one of embodiments 1 through 3, wherein the carrier fluid comprises a water-in-oil emulsion comprising an aqueous discontinuous phase dispersed in a continuous phase comprising the degradable oleaginous fluid.
6. The treatment fluid of any one of embodiments 1 through 5, wherein the particulate material comprises proppant.
7. The treatment fluid of any one of embodiments 1 through 6, further comprising a viscosifying agent.
8. The treatment fluid of any one of embodiments 1 through 7, wherein the particulate material comprises a second average particle size mode between three to twenty times smaller than a first average particle size mode.
9. The treatment fluid of any one of embodiments 1 through 8, further comprising a third average particle size mode, which is three to twenty times smaller than the second average particle size mode.
10. The treatment fluid of any one of embodiments 1 through 9, wherein the degradable oleaginous fluid is selected from the group consisting of an oleophilic monocarboxylic acid ester comprising from 3 to 40 carbon atoms, an oleophilic polycarboxylic acid ester comprising from 3 to 40 carbon atoms, an oleophilic ether comprising from 3 to 40 carbon atoms, an oleophilic alcohol comprising from 3 to 40 carbon atoms, and combinations thereof.
11. The treatment fluid of any one of embodiments 1 through 10, wherein the degradable oleaginous fluid is non-toxicological.
12. The treatment fluid of any one of embodiments 1 through 11, wherein the degradable oleaginous fluid undergoes hydrolysis upon contact with an aqueous fluid.
13. The treatment fluid of embodiment 12, wherein the degradable oleaginous fluid undergoes hydrolysis upon contact with the aqueous fluid wherein the aqueous fluid has a pH from about 9 to 14.
14. The treatment fluid of embodiment 12, wherein the degradable oleaginous fluid undergoes hydrolysis upon contact with the aqueous fluid, wherein the aqueous fluid has a pH from about 0 to 5.
15. The treatment fluid of any one of embodiments 12 through 14, further comprising a viscosifying agent, wherein a product of the hydrolysis comprises a breaker for the viscosifying agent.
16. A method comprising: providing a treatment fluid according to any one of embodiments 1 through 15, and introducing the treatment fluid into a wellbore.
17. A method comprising: providing a treatment fluid according to embodiment 15, introducing the treatment fluid into a wellbore, hydrolyzing the degradable oleaginous fluid, and breaking the viscosifying agent.
18. A method comprising: providing a treatment fluid comprising a plurality of particulates having an Apollonian particle size distribution dispersed in a carrier fluid, wherein the particulates, the carrier fluid, or both comprise a degradable oleaginous fluid; and introducing the treatment fluid into a wellbore.
19. The method of any one of embodiments 16 through 18, further comprising forming a pack comprising the proppant and the plurality of particles comprising the degradable oleaginous fluid downhole.
20. The method of embodiment 19, further comprising contacting the pack with an acid or a base in an amount sufficient to remove at least a portion of the particles comprising the degradable oleaginous fluid from the pack to form a permeable pack and producing or injecting a fluid through the permeable pack.
21. The method of any one of embodiments 16 through 20, further comprising viscosifying the treatment fluid with a viscosifying agent, and hydrolyzing the degradable oleaginous fluid to break the treatment fluid downhole.

### Examples

As shown in Table 1, three representative formulations were produced which resulted in a cross-linked gel. Comparative Sample A contains no oil, Sample B contains a degradable ester oil, and Comparative Sample C contains a paraffinic oil. In the case of Sample B, contact of the gel with an aqueous solution having a pH of 9 results in the ester oil undergoing hydrolysis to produce acid, thereby decreasing the pH of the gel from 9 to 7 over a period of 2 hours at 25° C. The consistency of the gel (i.e., the viscosity) also decreased from a gel to a liquid. In contrast, Comparative Samples A and C both remained as a gel at a constant pH of 9 under the same conditions.

TABLE 1

| | | Comparative | | Comparative |
|---|---|---|---|---|
| Component/Property | Units | Sample A | Sample B | Sample C |
| Water | mL | 100 | 100 | 100 |
| Ester Oil | mL | 0 | 10 | 0 |
| Paraffinic Oil | mL | 0 | 0 | 10 |
| Guar | g | 0.24 | 0.24 | 0.24 |
| Boron Crosslinker | mL | 0.6 | 0.6 | 0.6 |
| pH at t = 0 | | 9 | 9 | 9 |
| pH at t = 1 h | | 9 | 8 | 9 |
| pH at t = 2 h | | 9 | 7 | 9 |
| Consistency at t = 0 | | Gel | Gel | Gel |
| Consistency at t = 1 h | | Gel | Weak gel | Gel |
| Consistency at t = 2 h | | Gel | Liquid | Gel |

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

We claim:

1. A treatment fluid comprising:
a plurality of particulates having an Apollonian particle size distribution dispersed in a carrier fluid, wherein the particulates, the carrier fluid, or both comprise a degradable oleaginous fluid.

2. The treatment fluid of claim 1, further comprising a surfactant wherein a portion of the particulates comprise micelles.

3. The treatment fluid of claim 1, wherein the carrier fluid comprises the degradable oleaginous fluid as a continuous phase.

4. The treatment fluid of claim 1, wherein the carrier fluid comprises an oil-in-water emulsion or a water-in-oil-in-water emulsion comprising a discontinuous phase comprising the degradable oleaginous fluid dispersed in an aqueous continuous phase.

5. The treatment fluid of claim 1, wherein the carrier fluid comprises a water-in-oil emulsion comprising an aqueous discontinuous phase dispersed in a continuous phase comprising the degradable oleaginous fluid.

6. The treatment fluid of claim 1, wherein the particulate material comprises proppant.

7. The treatment fluid of claim 1, further comprising a viscosifying agent.

8. The treatment fluid of claim 1, wherein the particulate material comprises a second average particle size mode between three to twenty times smaller than a first average particle size mode.

9. The treatment fluid of claim 9, further comprising a third average particle size mode, which is three to twenty times smaller than the second average particle size mode.

10. The treatment fluid of claim 1, wherein the degradable oleaginous fluid is selected from the group consisting of an oleophilic monocarboxylic acid ester comprising from 3 to 40 carbon atoms, an oleophilic polycarboxylic acid ester comprising from 3 to 40 carbon atoms, an oleophilic ether comprising from 3 to 40 carbon atoms, an oleophilic alcohol comprising from 3 to 40 carbon atoms, and combinations thereof.

11. The treatment fluid of claim 1, wherein the degradable oleaginous fluid is non-toxicological.

12. The treatment fluid of claim 1, wherein the degradable oleaginous fluid undergoes hydrolysis upon contact with an aqueous fluid.

13. The treatment fluid of claim 12, further comprising a viscosifying agent, wherein a product of the hydrolysis comprises a breaker for the viscosifying agent.

14. A method comprising:
providing a treatment fluid comprising a plurality of particulates having an Apollonian particle size distribution dispersed in a carrier fluid, the particulates, the carrier fluid, or both comprising a degradable oleaginous fluid; and
introducing the fluid into a wellbore.

15. The method of claim 14, further comprising forming a pack comprising the proppant and the plurality of particles comprising the fluid downhole.

16. The method of claim 15, further comprising contacting the pack with an acid or a base in an amount sufficient to remove at least a portion of the particles comprising the degradable oleaginous fluid from the pack to form a permeable pack and producing or injecting a fluid through the permeable pack.

17. The method of claim 14, further comprising viscosifying the treatment fluid with a viscosifying agent, and hydrolyzing the degradable oleaginous fluid to break the treatment fluid downhole.
